(19) United States
(12) Patent Application Publication
(10) Pub. No.: US 2025/0239008 A1
(43) Pub. Date: Jul. 24, 2025

(54) ENCODING INDEPENDENT USER INTERFACE STREAMS TO PERFORM ASYNCHRONOUS REPROJECTION

(71) Applicant: Google LLC, Mountain View, CA (US)

(72) Inventors: Omar Estrada Diaz, Sacramento, CA (US); João Manuel de Castro Afonso, Lisbon (PT); Nuno Cruces, Portela (PT); Sazzadur Rahman, San Jose, CA (US); Konstantine Nicholas John Tsotsos, Corte Madera, CA (US)

(21) Appl. No.: 18/859,075

(22) PCT Filed: Apr. 24, 2023
(86) PCT No.: PCT/US2023/019563

§ 371 Date: Oct. 22, 2024

Related U.S. Application Data
(60) Provisional application No. 63/363,592, filed on Apr. 26, 2022.

(51) Int. Cl. G06T 17/00; G02B 27/01; G06T 5/50; G06T 9/00

(52) U.S. Cl. CPC G06T 17/00; G02B 27/017; G06T 5/50; G06T 9/00; G02B 2027/0178; G06T 2207/20221

(57) ABSTRACT

Techniques of performing time warp on an image include performing a time warp operation (e.g., asynchronous time warp) on a world-locked (WL) frame only to produce a warped WL frame. A smartphone, after receiving the image and IMU data from the smartglasses device, generates a pose for the world-facing camera. Based on the pose, the smartphone generates a world-locked (WL) portion of the image in the form of a pin used to mark a location in an image in world coordinates. The smartphone also generates a head-locked (HL) frame in the form of a description of the pin. A smartglasses device uses the IMU data to perform an asynchronous time warp of the WL frame.

### CROSS-REFERENCE TO RELATED APPLICATION

This application claims priority to U.S. Provisional Patent Application No. 63/363,592, filed on Apr. 26, 2022, entitled “SPLIT-COMPUTE ARCHITECTURE”, the disclosure of which is incorporated by reference herein in its entirety.

### TECHNICAL FIELD

This description relates in general to head mounted wearable devices and mobile devices, and in particular, to head mounted wearable computing devices including a display device.

### BACKGROUND

Eyewear in the form of glasses may be worn by a user to, for example, provide for vision correction, inhibit sun/glare, provide a measure of safety, and the like. These types of eyewear are typically somewhat flexible and/or deformable, so that the eyewear can be manipulated to comfortably fit the user and allow the eyewear to flex during use and wear by the user. An ophthalmic technician can typically manipulate rim portions and/or temple arm portions of a frame of the eyewear, for example, through cold working the frame and/or heating and re-working the frame, to adjust the eyewear for a particular user. In some situations, this re-working of the frame may occur over time, through continued use/wearing of the eyewear by the user. Manipulation in this manner, due to the flexible and/or deformable nature of the material of the frame and/or lenses of the eyewear, may provide a comfortable fit while still maintaining ophthalmic alignment between the eyewear and the user. In a situation in which the eyewear is a head mounted computing device including a display, such as, for example, smartglasses, this type of flexibility/deformation in the frame may cause inconsistent alignment or the display, or mis-alignment of the display. Inconsistent alignment, or mis-alignment of the display can cause visual discomfort, particularly in the case of a binocular display. A frame having rigid/non-flexible components, while still providing some level of flexibility in certain portions of the frame, may maintain alignment of the display, and may be effective in housing electronic components of such a head mounted computing device including a display.

### SUMMARY

This application is directed to performing a time warp operation (e.g., asynchronous time warp) on a world-locked (WL) frame to produce a warped WL frame. For example, a world-facing camera on a smartglasses device (or another wearable device having a display device) acquires an image of a scene as part of a navigation application. The smartglasses device is paired with a smartphone (or another companion device) as part of a split-compute architecture and sends the image of the scene, as well as inertial measurement unit (IMU) data, to the smartphone over a connection (e.g., a network interface connection, a wireless connection). The smartphone, after receiving the image and IMU data from the smartglasses device, generates a pose for the world-facing camera. Based on the pose, the smartphone generates the WL frame to be displayed on the glasses in the form of a location marker used to mark a location in world coordinates. The smartphone also generates a head-locked (HL) frame in the form of a description of the pin, locked to the bottom of the display. The smartphone separately encodes (compresses) both frames and sends the encoded WL and HL frames to the smartglasses device, with IMU data, via the connection. The smartglasses device then decodes (decompresses) the WL and HL frames. The smartglasses device uses the IMU data to perform a time warp (e.g., an asynchronous time warp) of the WL frame—that is, a repositioning of the WL frame (e.g., a location marker) in world coordinates based on the amount of movement made by the smartglasses device during the time it took to send the WL and HL frames to the smartglasses device. The smartglasses device then combines the time-warped WL frame and the HL frame and displays the combined frames in the display device of the smartglasses device.

In one general aspect, a method includes receiving, by a wearable device having a display device, a world-locked (WL) frame and a head-locked (HL) frame, the WL frame representing virtual objects having a fixed location in a world coordinate system, the HL frame representing virtual objects having a fixed location in the display device. The method also includes performing a time warp (TW) operation on the WL frame to produce a warped WL frame. The method further includes combining the warped WL frame and the HL frame to produce a combined image. The method can further include displaying the combined image in a display area produced by the display device. It is noted that, in some implementations, the wearable device may just receive the WL and the HL frames, perform a time warp operation on the WL frame and generate and display an image containing the warped WL frame and the HL frame. The HL frame may not be warped.

In another general aspect, a method includes providing a world-locked (WL) frame and a head-locked (HL) frame. The method further includes encoding the WL frame to produce encoded WL image. The method further includes encoding the HL frame to produce encoded HL image data. The method further includes transmitting the encoded WL image data to a wearable device, the wearable device being configured to perform a time warp (TW) operation on the WL frame. The method further includes transmitting the encoded HL image data to the wearable device. As mentioned above, in some implementations, the wearable device may just receive the WL and the HL frames, perform a time warp operation on the WL frame and generate and display an image containing the warped WL frame and the HL frame. The HL frame may not be warped.

In another general aspect, a wearable device includes memory and processing circuitry coupled to the memory. The processing circuitry is configured to receive a world-locked (WL) frame and a head-locked (HL) frame, the WL frame representing objects having a fixed location in a world coordinate system, the HL frame representing objects having a fixed location in a display device. The processing circuitry is also configured to perform a time warp (TW) operation on the WL frame to produce a warped WL frame. The processing circuitry is further configured to combine the warped WL frame and the HL frame to produce a combined image. The processing circuitry is further configured to display the combined image in a display area produced by a display device.

In another general aspect, a companion device includes memory and processing circuitry coupled to the memory. The processing circuitry is configured to provide a world-locked (WL) frame and a head-locked (HL) frame. The processing circuitry is further configured to encode the WL frame to produce encoded WL image data. The processing circuitry is further configured to encode the HL frame to produce encoded HL image data. The processing circuitry is further configured to transmit the encoded WL image data to a wearable device, the wearable device being configured to perform a time warp (TW) operation on the WL frame. The processing circuitry is further configured to transmit the encoded HL image data to the wearable device.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example system, in accordance with implementations described herein.

FIG. 1B is a front view, FIG. 1C is a rear view, and FIG. 1D is a perspective view, of the example head mounted wearable device shown in FIG. 1A, in accordance with implementations described herein.

FIG. 2 is a diagram that illustrates world-locked (WL) virtual objects and head-locked (HL) virtual objects in an example image.

FIG. 3 is a diagram that illustrates example information flow between the wearable device and the companion device.

FIG. 4 is a diagram that illustrates an example electronic environment for performing time warp on WL virtual objects in a wearable device.

FIG. 5 is a diagram that illustrates an example electronic environment for providing WL virtual objects and HL virtual objects in an image.

FIG. 6 is a flow chart that illustrates an example method of performing time warp on WL virtual objects.

FIG. 7 is a flow chart that illustrates an example method of providing WL virtual objects and HL virtual objects in an image.

### DETAILED DESCRIPTION

This disclosure relates to images captured by and displayed on wearable devices such as smartglasses.

Smartglasses can be configured to operate based on various constraints so that the smartglasses can be useful in a variety of situations. Example smart glasses constraints can include, for example, (1) smartglasses should amplify key services through wearable computing (this can include supporting technologies such as AR and visual perception): (2) smartglasses should have sufficient battery life (e.g., last at least a full day of use on a single charge); and (3) smart glasses should look and feel like real glasses. Smartglasses can include augmented reality (AR) and virtual reality (VR) devices. Fully stand-alone smartglasses solutions with mobile systems on chip (SoCs) that have the capability to support the desired features may not meet the power and industrial design constraints of smartglasses as described above. On-device compute solutions that meet constraints (1), (2) and (3) may be difficult to achieve with existing technologies.

A split compute architecture within smartglasses can be an architecture that moves the app runtime environment to a remote compute endpoint, such as a mobile device, a server, the cloud, a desktop computer, the like, hereinafter often referred to as a companion device for simplicity. In some implementations, data sources such as IMU and camera sensors can be streamed from the wearable device to the companion device. In some implementations, display content can be streamed from the compute endpoint back to the wearable device. In some implementations, because the majority of the compute and rendering does not happen on the wearable device itself, the split compute architecture can allow leveraging low-power MCU based systems. In some implementations, this can allow keeping power and ID in check, meeting at least constraints (1), (2) and (3). With new innovation in codecs and networking, it is possible to sustain the required networking bandwidth in a low power manner. In some implementations, a wearable device could connect to more than one compute endpoint at a given time. In some implementations, different compute endpoints could provide different services. In some implementations, with low-latency, high-bandwidth 5G connections becoming mainstream, compute endpoints could operate in the cloud.

In some implementations, a split compute architecture can move the application runtime environment from the wearable device to a remote endpoint such as a companion device (phone, watch) or cloud. Wearable device hardware only does the bare minimum, such as streaming of data sources (Camera, IMU, audio), pre-processing of data (e.g., feature extraction, speech detection) and finally the decoding and presentation of visuals.

Doing less on the wearable device can enable reducing the hardware and power requirements. In some implementations, a split-compute architecture may reduce the size of the temples. In some implementations, a split-compute architecture may enable leveraging large ecosystems. In some implementations, a split-compute architecture may enable building experiences that are no longer limited by the hardware capabilities of the wearable device.

World-locked (WL) content are digital (virtual) objects that appear to be fixed to a location in the real-world. Head-locked (HL) content are digital objects whose location is fixed to the screen. WL content may be used for applications such as navigation that rely on placing virtual objects in the real-world to give users accurate indications. Rendering WL objects can require obtaining the wearable device's pose and the perspective of the wearable device with respect to the world. The pose can be determined using camera imagery (e.g., provided by the wearable device) or sensor data (e.g., IMU data). Also, a combination of camera imagery and IMU data may be used. A wearable device software development kit (SDK) can obtain the pose (computed on a companion device) from the wearable device's camera and IMU.

A technical problem with the above-mentioned split-compute architecture is that there is latency introduced when the data travels between the companion device and the wearable device. Accordingly, rendering WL content based on a slightly outdated pose can lead to unregistered experiences (e.g., experiences where the object is misplaced with respect to the real-world). Such unregistered experiences can lead to inaccurate navigation and confusion on part of the user.

A technical solution to the above technical problem includes performing a time warp operation (e.g., asynchronous time warp) on a WL frame only to produce a warped WL frame. For example, a world-facing camera on a smartglasses device acquires an image of a scene as part of a navigation application. The smartglasses device is paired with a smartphone as part of a split-compute architecture and sends the image of the scene, as well as inertial measurement unit (IMU) data (or the IMU data only), to the smartphone over a network interface. The smartphone, after receiving the image and IMU data from the smartglasses device, generates a pose for the world-facing camera. Based on the pose, the smartphone generates a world-locked (WL) frame in the form of a location marker used to mark a location in the image in world coordinates. The smartphone also generates a head-locked (HL) frame in the form of a description of the location marker, locked to the bottom of the display. The smartphone separately encodes (compresses) the WL frame and the HL frame and sends the encoded WL and HL frames to the smartglasses device, with IMU data, via the network interface. The smartglasses device then decodes (decompresses) the WL and HL frames. The smartglasses device uses current IMU data to perform an asynchronous time warp of the WL frame—that is, a repositioning of the location marker in world coordinates based on the amount of movement made by the smartglasses device during the time it took to send the WL and HL frames to the smartglasses device. The smartglasses device then combines the time-warped WL frame and the HL frame and displays the combined image in the display device of the smartglasses device.

A technical advantage of the above-described technical solution is that the warped WL frame is combined with an HL frame to produce an image with a more accurate placement of the WL frame. This contributes to an increase (e.g., improve, maximize) of the battery life of the wearable device provided by the split-compute architecture.

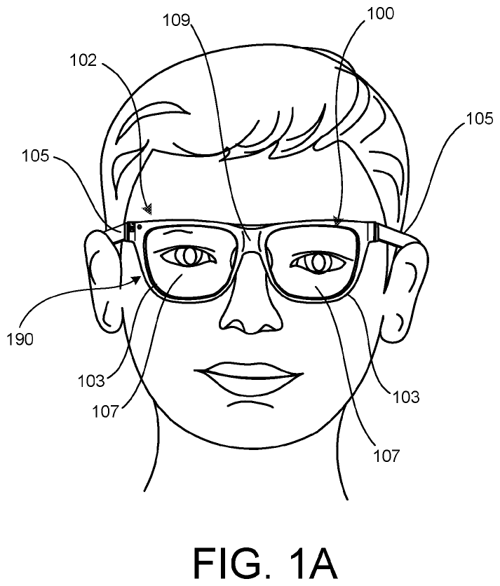

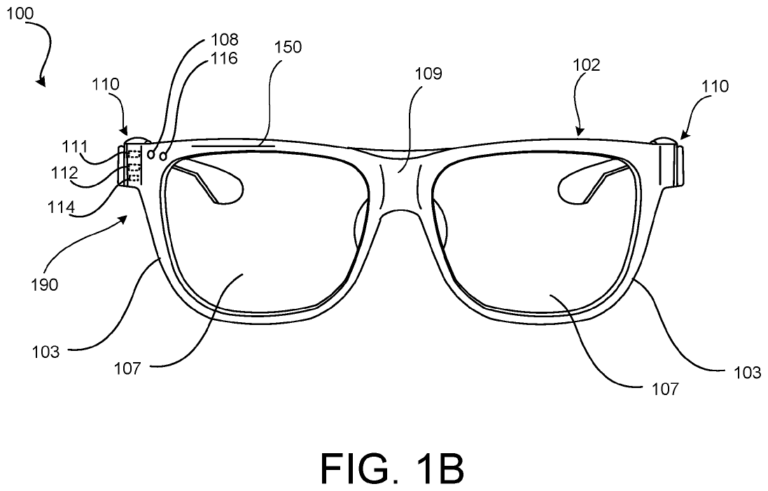

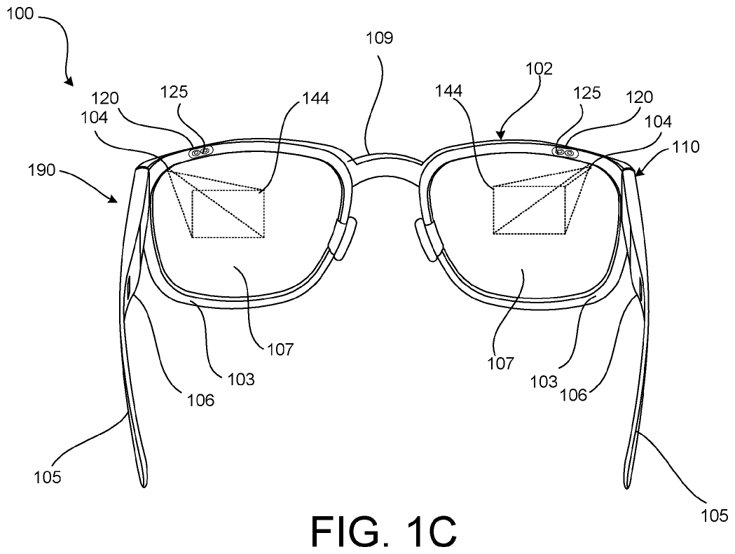

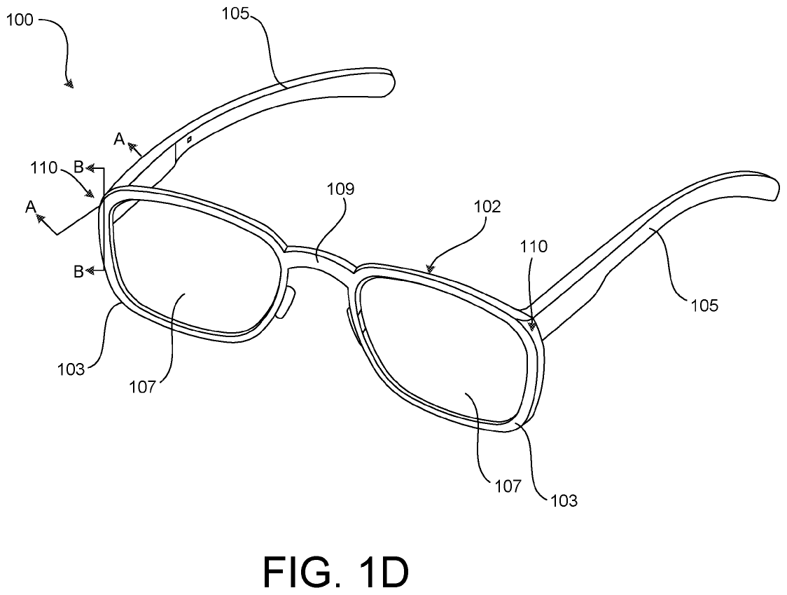

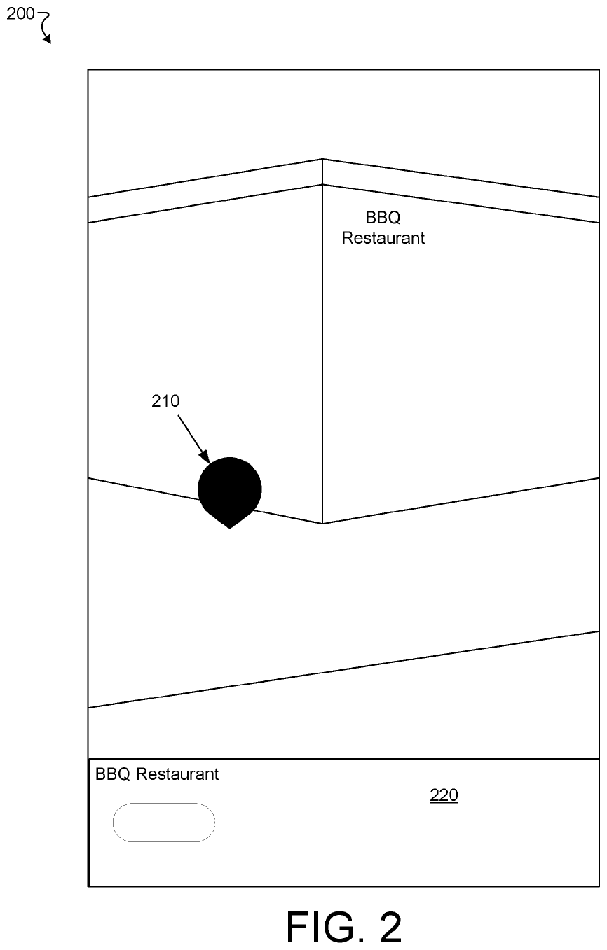

FIG. 1A illustrates a user wearing an example head mounted wearable device 100. In this example, the example head mounted wearable device 100 is in the form of example smartglasses including display capability and computing/processing capability, for purposes of discussion and illustration. The principles to be described herein may be applied to other types of eyewear, both with and without display capability and/or computing/processing capability. FIG. 1B is a front view, FIG. 1C is a rear view, and FIG. 2D is a perspective view, of the example head mounted wearable device 100 shown in FIG. 1A. As noted above, in some examples, the example head mounted wearable device 100 may take the form of a pair of smartglasses, or augmented reality glasses. The head mounted wearable device 100 shown in FIGS. 1A through ID includes a nose bridge 109, rim portions 103, and respective arm portions 105. The junctions between the rim portions 103 and arm portions 105 form shoulders. The material in the nose bridge 109 has a first bending stiffness and the material in the shoulders has a second bending stiffness such that the first bending stiffness and the second bending stiffness satisfy a specified relationship.

As shown in FIG. 1B-ID, the example head mounted wearable device 100 includes a frame 102 worn by a user. The frame 102 includes a front frame portion defined by rim portions 103 surrounding respective optical portions in the form of lenses 107, with a bridge portion 109 connecting the rim portions 109. Arm portions 105 are coupled, for example, pivotably or rotatably coupled, to the front frame by hinge portions 110 at the respective rim portion 103. In some examples, the lenses 107 may be corrective/prescription lenses. In some examples, the lenses 107 may be an optical material including glass and/or plastic portions that do not necessarily incorporate corrective/prescription parameters. A display device 104 may be coupled in a portion of the frame 102. In the example shown in FIGS. 1B and 1C, the display device 104 is coupled in the arm portion 105 of the frame 102. With the display device 104 coupled in the arm portion 105, an eye box 140 extends toward the lens(es) 107, for output of content at an output coupler 144 at which content output by the display device 104 may be visible to the user. In some examples, the output coupler 144 may be substantially coincident with the lens(es) 107. In some examples, the head mounted wearable device 100 can also include an audio output device 106 (such as, for example, one or more speakers), an illumination device 108, a sensing system 111, a control system 112. at least one processor 114, and an outward facing image sensor 116, or world-facing camera 116.

In some implementations, the at least one processor 114 is configured to perform separate decodings of world-locked (WL) and head-locked (HL) frames. In some implementations, the at least one processor 114 is also configured to perform a time warping operation (e.g., asynchronous time warp) on the (decoded) WL frame (only). In some implementations, the at least one processor 114 is also configured to combine the warped, WL frame with the HL frame to produce a combined image. In some implementations, the at least one processor 114 is also configured to display the combined image in the display device 104.

FIG. 2 is a diagram that illustrates world-locked (WL) virtual objects 210 and head-locked (HL) virtual objects 220. As shown in FIG. 2, the image 200 is of a scene including a BBQ restaurant. The WL virtual object is a location marker 210 is placed in a location in a world coordinate system (e.g., GPS coordinates—a coordinate system fixed to the world). The HL virtual object is a descriptor 220 placed at the bottom, e.g., in a head-locked location. The WL portion of the image—the frame that is fixed to a location in the real world—includes the location marker 210, while the HL portion of the image—the frame that is fixed to a location in the display—includes the descriptor 220.

For example, a world-facing camera on a smartglasses device acquires the image 200 as part of a navigation application. The smartglasses device is paired with a smartphone as part of a split-compute architecture and sends the image of the scene 200, as well as inertial measurement unit (IMU) data, to the smartphone over a network interface. The smartphone, after receiving the image and IMU data from the smartglasses device. generates a pose for the world-facing camera. Based on the pose, the smartphone generates a world-locked (WL) frame including a location marker used to mark a location in the image in world coordinates. The smartphone also generates a head-locked (HL) frame including a description of the location marker, locked to a region (e.g., the bottom) of the display. The smartphone separately encodes (compresses) the WL frame 210 and the HL frame 220 and sends the encoded WL 210 and HL 220 frames to the smartglasses device, with metadata derived from the sensor dfata originally sent by the wearable device, via the network interface. The smartglasses device then decodes (decompresses) the WL 210 and HL 220 frames. The smartglasses device uses the matadata, in conjunction with data from the smartglasses device sensors, to perform an asynchronous time warp of the WL frame 210—that is, a repositioning of the location marker in world coordinates based on the amount of movement made by the smartglasses device during the time it took to send the WL 210 and HL 220 frames to the smartglasses device. The smartglasses device then combines the time-warped WL frame 210 and the HL frame 220 with the image and displays the combined image in the display device of the smartglasses device. The image 200 depicted in FIG. 2 illustrates how the image would look like if the WL virtual object had not been warped. Such an image, however, is not actually generated by the wearable device. Rather, only an image (above referred to as the “combined image”) containing the warped WL virtual object and the HL virtual object is produced and displayed.

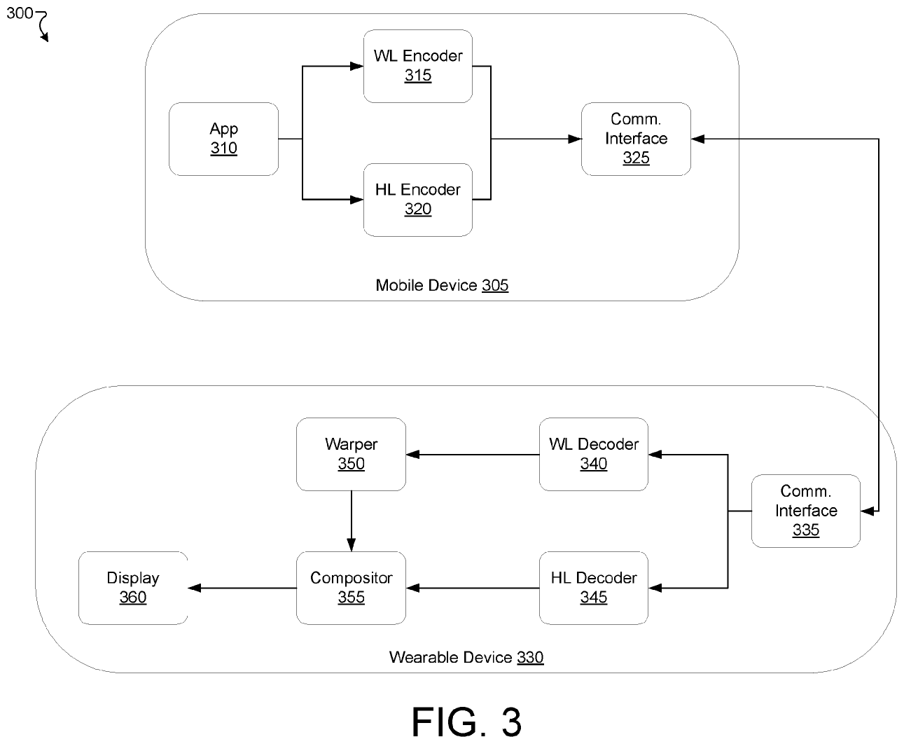

FIG. 3 is a diagram that illustrates example information flow between a wearable device 330 and a companion device 305. As shown in FIG. 3, the companion device 305 includes an application 310, a WL encoder 315, a HL encoder 320, and a communication interface (protocol handler) 325. The wearable device 330 includes a communication interface (protocol handler) 335, a WL decoder 340, a HL decoder 345, a warper 350, a compositor 355, and a display 360 (e.g., display device 104 in FIG. 1A).

In some implementations, the wearable device 330 sends an image (e.g., image data) and IMU data to the companion device 305 via communication interfaces 335 and 325, respectively. In some implementations, the wearable device 330 only sends IMU data to the companion device 305 via communication interfaces 335 and 325. At the companion device, an application (“app”) 310 is configured to generate a pose for the world-facing camera that acquired the image based on the IMU data. The app 310 then generates a WL frame—such as a location marker—based on the generated pose. The app 310 also generates an HL frame—such as a descriptor. In some implementations, the app 310 uses a software library for customizing the WL and HL frame.

The app 310 then sends the WL frame to the WL encoder 315 and the HL frame to the HL encoder 320 for encoding. In some implementations, the encoding is in both cases a common encoding (e.g., the encoding is the same for the WL frame and the HL frame). In some implementations, the common encoding is H.264 encoding. In some implementations, the app 310 sends WL frames at a different rate than HL frames. In some implementations, the app 310 send WL frames to the WL encoder 315 at a higher rate than it sends HL frames to the HL encoder 320.

The WL encoder 315 sends encoded WL frames to the communication interface 325, and the HL encoder 320 sends encoded HL frames to the communication interface 325. In some implementations, in which the app 310 sends WL portions to the WL encoder 315 at a different rate at which the app 310 sends HL frames to the HL encoder 320. the WL encoder 315 sends encoded WL frames to the wearable device 330 at different times than the HL encoder 320 sends encoded HL frames to the wearable device 330.

Upon receipt, the communications interface 335 of the wearable device 330 sends each WL encoded frame to the WL decoder 340 and each HL frame to the HL decoder 345. In addition, in some implementations, the communication interface 335 sends metadata from the companion device 305 to the warper 350.

The WL decoder 340 decodes (decompresses) encoded WL frames to produce the WL frames. The HL decoder 345 decodes (decompresses) encoded HL frames to produce the HL frames.

The WL decoder 340, after decoding, sends the decoded WL frame to the warper 350. The warper 350 is configured to perform a time warp operation on the WL frame. A time warp operation such as asynchronous time warp (ATW) involves moving the WL frame over some number of pixels in a direction of anticipated motion. For example, if the sensor data in the wearable device and the metadata sent from the companion device indicates that the wearable device 330 was moving to the right while the WL frame was being sent to the wearable device, then the warper 350 moves the WL frame to the right by some number of pixels. In some implementations, the direction of motion and number of pixels moved is based on the metadata sent by the companion device with the encoded WL frame.

The HL decoder 345, after decoding, sends the HL frame to the compositor 355. The warper 350, after performing the time warp operation on the WL frame, sends the warped WL frame to the compositor 355. The compositor 355 is configured to combine the HL frame and the warped WL frame to form a combined image for display on the display 360. In some implementations, the compositor 355 is configured to add pixels of the warped WL frame to pixels of the HL frame. In some implementations, the compositor 355 is configured to average pixels of the warped WL frame ge and pixels of the HL frame. In some implementations, the average is a weighted average.

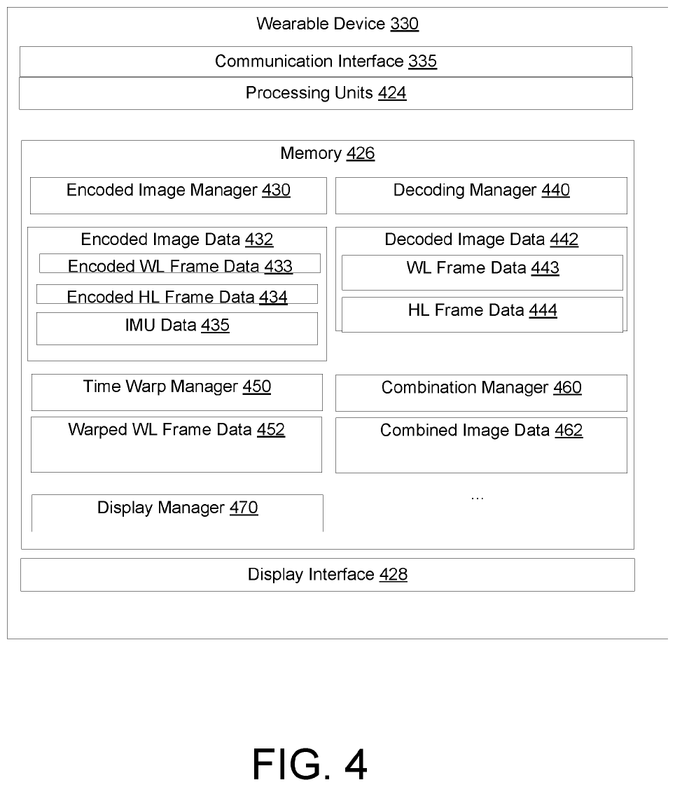

FIG. 4 is a diagram that illustrates an example electronic environment for performing time warp on WL virtual objects in the wearable device 330. The wearable device 330 includes the communication interface 335, one or more processing units 424, and nontransitory memory 426.

In some implementations, one or more of the components of the wearable device 330 can be, or can include processors (e.g., processing units 424) configured to process instructions stored in the memory 426. Examples of such instructions as depicted in FIG. 4 include encoded image manager 430, decoding manager 440, time warp manager 450, combination manager 460, and display manager 470. Further, as illustrated in FIG. 4, the memory 426 is configured to store various data, which is described with respect to the respective managers that use such data.

The encoded image manager 430 is configured to receive encoded world-locked (WL) and head-locked (HL) frames from a companion device (e.g., companion device 305 in FIG. 3). The received encoded WL and HL frames are stored in encoded image data 432 as encoded WL frame data 433 and encoded HL frame data 434, respectively. In some implementations, the encoded image manager 430 is configured to receive IMU data from the companion device: this is stored as IMU data 435.

The decoding manager 440 is configured to decode the encoded image data 432 to produce decoded image data 442, which includes WL frame data 443 and HL frame data 444. Decoding manager 442 corresponds to WL decoder 340 and HL decoder 345 in FIG. 3.

The time warp manager 450 is configured to perform a time warp operation on decoded WL frame data 443 to produce warped WL frame data 452. A time warp operation includes moving the WL frame some number of pixels in a specified direction. The direction and number of pixels is, in some implementations, provided by the IMU data 435. The time warp operation compensates for the time lag induced by the sending of the WL and HL frames between the companion device 305 and the wearable device 330.

The combination manager 460 is configured to combine the warped WL frame data 452 and the HL frame data 444 to produce combined image data 462. For example, the combination manager 460 adds pixels from the warped WL frame data 452 and the HL frame data 444 to pixels of the original image to produce the combined image data 462. In some implementations, the combination manager 460 averages the pixels. In some implementations, the averaging is a weighted averaging.

The display manager 470 sends the combined image data 462 to the display device of the wearable device 330 (via display interface 428) for display.

The components (e.g., modules, processing units 424) of wearable device 330 can be configured to operate based on one or more platforms (e.g., one or more similar or different platforms) that can include one or more types of hardware, software, firmware, operating systems, runtime libraries, and/or so forth. In some implementations, the components of the wearable device 330 can be configured to operate within a cluster of devices (e.g., a server farm). In such an implementation, the functionality and processing of the components of the wearable device 330 can be distributed to several devices of the cluster of devices.

The components of the wearable device 330 can be, or can include, any type of hardware and/or software configured to perform time warp operations on WL portions of an image. In some implementations, one or more portions of the components shown in the components of the wearable device 330 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the wearable device 330 can be, or can include, a software module configured for execution by at least one processor (not shown). In some implementations, the functionality of the components can be included in different modules and/or different components than those shown in FIG. 4, including combining functionality illustrated as two components into a single component. The communication interface 335 includes, for example, Ethernet adaptors, Token Ring adaptors, and the like, for converting electronic and/or optical signals received from the network to electronic form for use by the wearable device 330. The set of processing units 424 include one or more processing chips and/or assemblies. The memory 426 includes both volatile memory (e.g., RAM) and non-volatile memory, such as one or more ROMs, disk drives, solid state drives, and the like. The set of processing units 424 and the memory 426 together form processing circuitry, which is configured and arranged to carry out various methods and functions as described herein.

Although not shown, in some implementations, the components of the wearable device 330 (or portions thereof) can be configured to operate within, for example, a data center (e.g., a cloud computing environment), a computer system, one or more server/host devices, and/or so forth. In some implementations, the components of the wearable device 330 (or portions thereof) can be configured to operate within a network. Thus, the components of the wearable device 330 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the wearable device 330 can be, or can include, processors configured to process instructions stored in a memory. For example, encoded image manager 430 (and/or a portion thereof), decoding manager 440 (and/or a portion thereof), time warp manager 450 (and/or a portion thereof), combination manager 460 (and/or a portion thereof), and display manager 470 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processing circuitry 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processing circuitry 420. As illustrated in FIG. 4, the memory 426 is configured to store various data, including encoded image data 432, decoded image data 442, and warped WL frame data 452.

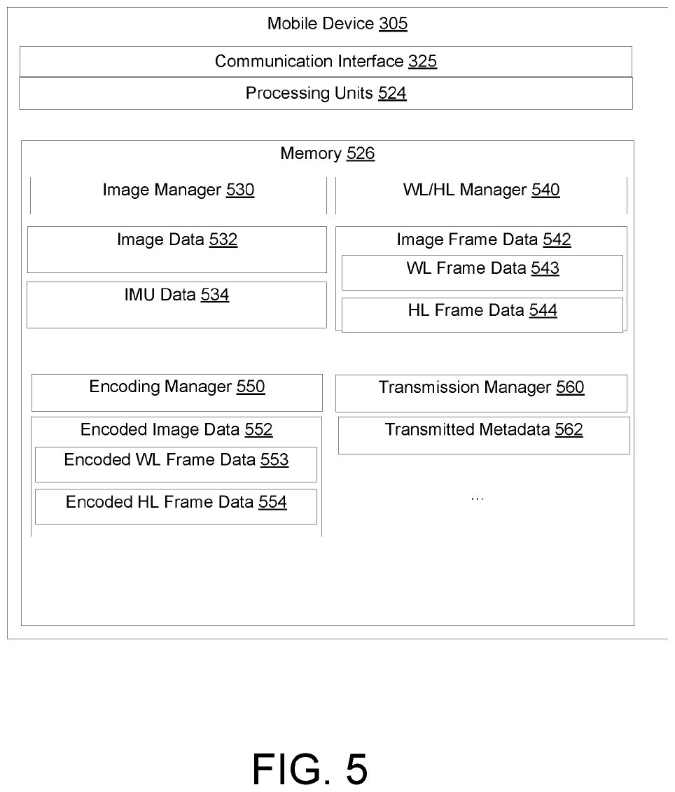

FIG. 5 is a diagram that illustrates an example companion device 305 for providing WL virtual objects and HL virtual objects in an image. The companion device 305 includes the communication interface 325, one or more processing units 524, and nontransitory memory 526.

In some implementations, one or more of the components of the wearable device 330 can be, or can include processors (e.g., processing units 524) configured to process instructions stored in the memory 526. Examples of such instructions as depicted in FIG. 5 include image manager 530, WL/HL manager 540, encoding manager 550, and transmission manager 560. Further, as illustrated in FIG. 5, the memory 526 is configured to store various data, which is described with respect to the respective managers that use such data.

The image manager 530 is configured to receive image data 532 (e.g., camera image data) from the wearable device 330 (FIGS. 3 and 4) over communication interface 325. In some implementations, the image manager 530 is configured to receive IMU data 534 from the wearable device 330. In some implementations, the image manager 530 is configured to receive only IMU data from the wearable device 330.

The WL/HL manager 540 is configured to provide a WL frame and an HL frame. To provide the WL frame, the WL/HL manager 540 is configured to generate a pose of the world-facing camera (and hence the image). In some implementations, the pose is based on the IMU data 534.

The encoding manager 550 is configured to produce encoded image data 552 by separately encoding the WL frame data 542 and the HL frame data 544; the encoded image data includes encoded WL frame data 553 and encoded HL frame data 554. In some implementations, the encoding of the WL frame data 543 and the HL frame data 544 is performed using a common encoding scheme (e.g., the same encoding scheme). In some implementations, the common encoding scheme is H.264 encoding.

The transmission manager 560 is configured to transmit the encoded WL frame data 553 and the encoded HL frame data 554 to the wearable device 330 (FIGS. 3 and 4). In some implementations, the transmission manager 560 transmits the encoded WL frame data 553 and the encoded HL frame data 554 at different rates and/or at different times. In some implementations, the transmission manager 560 is also configured to transmit metadata 562 from the companion device 305 to the wearable device 330. In some implementations, the transmission manager 560 transmits the metadata 562 with the encoded WL frame data 553.

The components (e.g., modules, processing units 524) of companion device 305 can be configured to operate based on one or more platforms (e.g., one or more similar or different platforms) that can include one or more types of hardware, software, firmware, operating systems, runtime libraries, and/or so forth. In some implementations, the components of the companion device 305 can be configured to operate within a cluster of devices (e.g., a server farm). In such an implementation, the functionality and processing of the components of the companion device 305 can be distributed to several devices of the cluster of devices.

The communication interface 325 includes, for example, Ethernet adaptors, Token Ring adaptors, and the like, for converting electronic and/or optical signals received from the network to electronic form for use by the companion device 305. The set of processing units 524 include one or more processing chips and/or assemblies. The memory 526 includes both volatile memory (e.g., RAM) and non-volatile memory, such as one or more ROMs, disk drives, solid state drives, and the like. The set of processing units 524 and the memory 526 together form processing circuitry, which is configured and arranged to carry out various methods and functions as described herein.

The components of the companion device 305 can be, or can include, any type of hardware and/or software configured to provide WL and HL portions of an image. In some implementations, one or more portions of the components shown in the components of the companion device 305 in FIG. 5 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the companion device 305 can be, or can include, a software module configured for execution by at least one processor (not shown). In some implementations, the functionality of the components can be included in different modules and/or different components than those shown in FIG. 5, including combining functionality illustrated as two components into a single component.

Although not shown, in some implementations, the components of the companion device 305 (or portions thereof) can be configured to operate within, for example, a data center (e.g., a cloud computing environment), a computer system, one or more server/host devices, and/or so forth. In some implementations, the components of the companion device 305 (or portions thereof) can be configured to operate within a network. Thus, the components of the companion device 305 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the companion device 305 can be, or can include, processors configured to process instructions stored in a memory. For example, image manager 530 (and/or a portion thereof), WL/HL manager 5540 (and/or a portion thereof), encoding manager 550 (and/or a portion thereof), and transmission manager 560 (and/or a portion thereof) are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the companion device 305. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the companion device 305. As illustrated in FIG. 5, the memory 526 is configured to store various data, including image data 532, image frame data 542, and encoded image data 552.

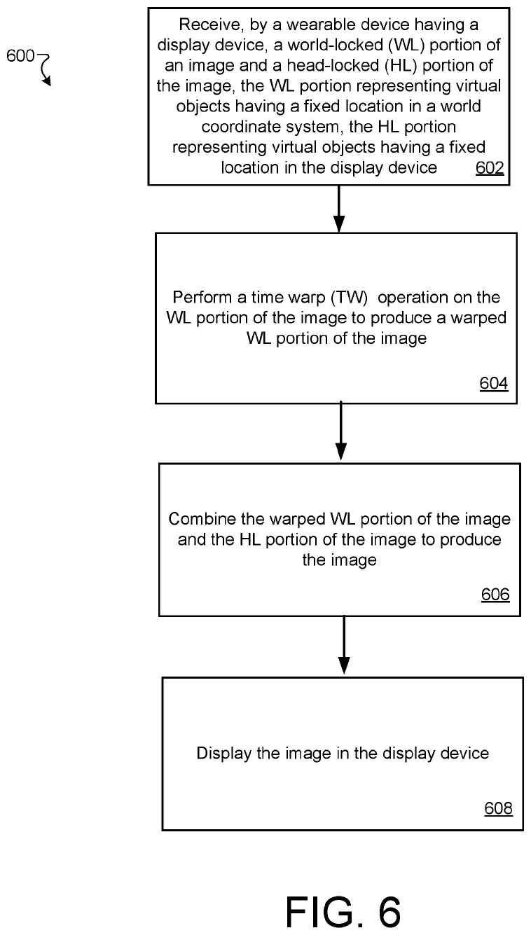

FIG. 6 is a flow chart that illustrates an example method 600 of performing time warp on WL virtual objects. The method 600 may be performed using the wearable device 330 of FIGS. 3 and 4.

At 602, the wearable device 330 receives a world-locked (WL) frame and a head-locked (HL) frame, the WL frame representing virtual objects having a fixed location in a world coordinate system, the HL frame representing virtual objects having a fixed location in the display device.

At 604, the time warp manager 450 performs a time warp (TW) operation on the WL frame to produce a warped WL frame.

At 606, the combination manager 460 combines the warped WL frame and the HL frame to produce a combined image.

At 608, the display manager 470 displays the combined image in a display device.

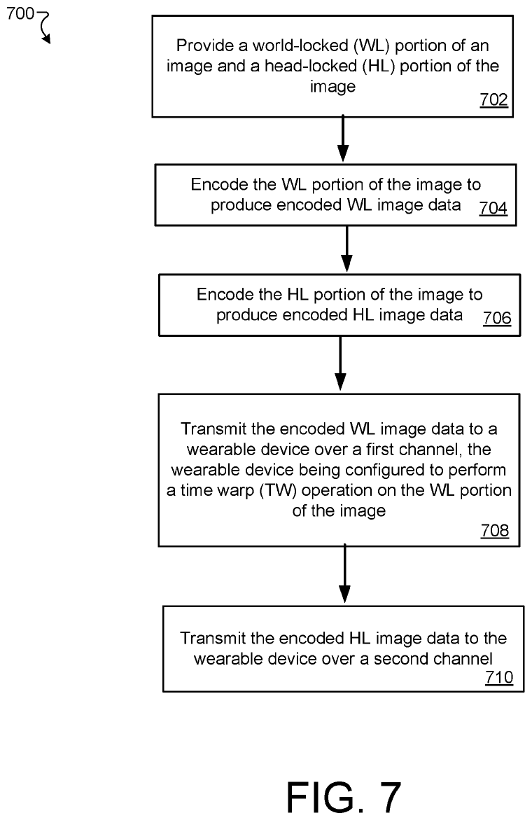

FIG. 7 is a flow chart that illustrates an example method 700 of providing WL virtual objects and HL virtual objects in an image. The method 700 may be performed using the companion device 305 of FIGS. 3 and 5.

At 702, the WL/HL manager 540 provides a world-locked (WL) frame and a head-locked (HL) frame.

At 704, the encoding manager 550 encodes the WL frame to produce encoded WL image data.

At 706, the encoding manager 550 encodes the HL frame to produce encoded HL image data.

At 708, the transmission manager 560 transmits the encoded WL image data to a wearable device over a first channel, the wearable device being configured to perform a time warp (TW) operation on the WL frame.

At 710, the transmission manager 560 transmits the encoded HL image data to the wearable device over a second channel.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A method, comprising:
receiving, by a wearable device having a display device, a world-locked (WL) frame and a head-locked (HL) frame, the WL frame representing virtual objects having a fixed location in a world coordinate system, the HL frame representing virtual objects having a fixed location in a display area produced by the display device;
performing a time warp (TW) operation on the WL frame to produce a warped WL frame;
combining the warped WL frame and the HL frame to produce a combined image; and
displaying the combined image in the display device.

2. The method as in claim 1, wherein a time warp operation is not performed on the HL frame.

3. The method as in claim 1, further comprising:
receiving, from a companion device, encoded WL image data representing the WL frame and encoded HL image data representing the HL frame;
decoding the encoded WL image data to produce the WL frame; and
decoding the encoded HL image data to produce the HL frame.

4. The method as in claim 3, wherein the encoded WL image data and the encoded HL image data are received at different times.

5. The method as in claim 3, wherein the encoded WL image data and the encoded HL image data are received at different rates.

6. The method as in claim 1, wherein combining the warped WL frame and the HL frame includes:
combining the warped WL frame with a most recent version of the HL frame.

7. The method as in claim 3, wherein the encoded WL image data and/or the encoded HL image are encoded using a common encoding scheme.

8. The method as in claim 7, wherein the common encoding scheme comprise a data compression scheme.

9. The method as in claim 3, wherein the companion device and the wearable device are connected using a Bluetooth connection.

10. The method as in claim 3, wherein performing the TW operation on the WL frame includes:
receiving metadata from the companion device and/or data from a sensor of the wearable device, the metadata and data representing a change in position of the companion device or the wearable device over a specified time or a current position of the companion device or the wearable device.

11. A method, comprising:
providing, by a companion device, a world-locked (WL) frame and a head-locked (HL) frame;
encoding the WL frame to produce encoded WL image data;
encoding the HL frame to produce encoded HL image data;
transmitting the encoded WL image data to a wearable device, the wearable device being configured to perform a time warp (TW) operation on the WL frame; and
transmitting the encoded HL image data to the wearable device.

12. The method as in claim 11, wherein the encoded WL image data and the encoded HL image data are transmitted at different times.

13. The method as in claim 11, wherein the encoded WL image data and the encoded HL image data are transmitted at different rates.

14. The method as in claim 11, wherein the encoded WL image data and the encoded HL image are encoded using a common encoding scheme.

15. The method as in claim 11, wherein the companion device and the wearable device are connected using a Bluetooth connection.

16. The method as in claim 11, further comprising:
transmitting metadata from a sensor of the wearable device, the data representing a change in position over a specified time.

17. A wearable device, comprising:
memory; and
processing circuitry coupled to the memory, the processing circuitry being configured to:
receive a world-locked (WL) frame and a head-locked (HL) frame, the WL frame representing objects having a fixed location in a world coordinate system, the HL frame representing objects having a fixed location in a display area produced by a display device;
perform a time warp (TW) operation on the WL frame to produce a warped WL frame;
combine the warped WL frame and the HL frame to produce a combined image; and
display the combined image in the display device.

18. The wearable device as in claim 17, wherein the processing circuitry is further configured to:
receive, from a companion device, encoded WL image data representing the WL frame and encoded HL image data representing the HL frame;
decode the encoded WL image data to produce the WL frame; and
decode the encoded HL image data to produce the HL frame.

19. The wearable device as in claim 17, wherein the encoded WL image data and the encoded HL image data are received at different times.

20. The wearable device as in claim 17, wherein the encoded WL image data and the encoded HL image data are received at different rates.

21. The wearable device as in claim 17, wherein the processing circuitry configured to combine the warped WL frame and the HL frame is further configured to:
combine the warped WL frame with a most recent version of the HL frame.

22. The wearable device as in claim 17, wherein the encoded WL image data and the encoded HL image are encoded using a common encoding scheme.

23. The wearable device as in claim 18, wherein the companion device and the wearable device are connected using a Bluetooth connection.

24. The wearable device as in claim 17, wherein the processing circuitry configured to perform the TW operation on the WL portion of the first image is further configured to:
receiving metadata from the companion device and/or data from a sensor of the wearable device, the metadata and data representing a change in position of the companion device or the wearable device over a specified time or a current position of the companion device or the wearable device.

25. A companion device, comprising:
memory; and
processing circuitry coupled to the memory, the processing circuitry being configured to:
provide a world-locked (WL) frame and a head-locked (HL) frame;
encode the WL frame to produce encoded WL image data;
encode the HL frame to produce encoded HL image data;
transmit the encoded WL image data to a wearable device, the wearable device being configured to perform a time warp (TW) operation on the WL frame; and
transmit the encoded HL image data to the wearable device.

26. The companion device as in claim 25, wherein the encoded WL image data and the encoded HL image data are transmitted at different times.

27. The companion device as in claim 25, wherein the encoded WL image data and the encoded HL image data are transmitted at different rates.

28. The companion device as in claim 25, wherein the encoded WL image data and the encoded HL image are encoded using a common encoding scheme.

29. The companion device as in claim 25, wherein the companion device and the wearable device are connected using a Bluetooth connection.

30. The companion device as in claim 25, wherein the processing circuitry is further configured to:
transmit metadata from a sensor of the wearable device, the data representing a change in position over a specified time.
